(19) United States
(12) Patent Application Publication
(10) Pub. No.: US 2004/0221050 A1
(43) Pub. Date: Nov. 4, 2004

(54) Direct TCP/IP communication method and system for coupling to a CPU/Memory complex

(76) Inventor: Graham Smith, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/429,134

(22) Filed: May 2, 2003

(51) Int. Cl. G06F 15/16; G06F 15/173

(52) U.S. Cl. 709/230; 709/238

(57) ABSTRACT

Computer system that includes a processor/memory complex and a TCP/IP controller integrated with the processor/memory complex. The TCP/IP controller supports TCP/IP connections to and from the processor/memory complex. The TCP/IP controller executes the TCP/IP protocol on data received from a network connection and data to be sent to a network connection.

### FIELD OF THE INVENTION

The present invention relates generally to network controllers, and more particularly, to a direct TCP/IP communication method and system for coupling to a CPU/memory complex.

### BACKGROUND OF THE INVENTION

FIG. 1 illustrates a prior art computer system 1. The computer system 1 includes one or of processors (e.g., a first CPU 2 and a second CPU 3), a memory 5, a memory controller 4 for controlling access to the memory 5, an input/output (I/O) bus (e.g., a PCI bus 9), and an input/output (I/O) controller 6 for controlling access to the I/O bus 9. The processors (e.g., the first CPU 2 and the second CPU 3), memory controller 4, and the I/O controller 6 are coupled to a CPU/memory bus 7 through which information is communicated.

The computer system 1 also includes a number of physical slots (e.g., PCI slots) for receiving adapter cards. The adapter cards are utilized to connect the computer system to external peripheral devices such as disk drives or other computer systems either directly or via networks. As noted previously, the I/O bus (e.g., PCI bus 9) is controlled by the I/O controller 6 (commonly known as a “South bridge”). Specifically, the I/O controller 6 controls the exchange of data and control messages between a processor (e.g., first CPU 2 or second CPU 3), memory controller 4, and the adapter cards (e.g., Ethernet adapter card 8).

In this example, the system 1 is coupled to a network (e.g., an IP switch 10) through an Ethernet adapter card 8. In this manner, data (e.g., IP packets) can be received by the system 1 from the network or sent from the system 1 to the network.

As a processor executes instructions, an instruction may require data from an I/O device that is coupled to one of the I/O adapter cards. A read operation is then performed to read the data from the I/O device. Similarly, an instruction may require that data be written to a particular I/O device that is coupled to one of the I/O adapter cards. A write operation is then performed to write data to the I/O device.

As data is transferred across the I/O bus 9 and I/O controller 6 from/to the adapter cards and the CPU or memory 5, it is incurring latency (i.e., expending time), which reduces the performance of the applications which are waiting for the data to arrive or to be delivered.

One measure of the performance of the computer system is the amount of time required for reading data from I/O devices and the time required for writing data to I/O devices.

I/O subsystem performance/latency

As data flows from the network point of attachment to the CPU or memory, the data is subject to the following delays.

A first time (t_adapter) is expended by the network adapter 8 to receive Ethernet frames, to reassemble the frames into the IP packets, to check for errors and to interrupt the host CPU for permission to send data. When permission is granted, the network adapter 8 sends the data on the I/O bus 9 tagged with a memory address. The network adapter 8 also arbitrates for access to the I/O bus 9 for each interrupt and data transfer.

A second time (t_ibus) is expended by the network adapter 8 to arbitrate for and be granted access to I/O bus 9 and to transfer data to the I/O controller 6. This time is non-deterministic due to competing requests for access to the I/O bus 9 from other adapter cards and the I/O controller 6 for outbound traffic.

A third time (t_bridge) is expended for the I/O controller 6 to receive data (e.g., from the input buffers connected to the I/O bus) and to check the data for errors.

A fourth time (t_mbus) is expended by the I/O controller 6 to arbitrate for and be granted access to CPU/Memory bus 7 and to transfer data to memory controller 4. This time is non-deterministic due to competing requests for access to the bus 7 from CPUs (e.g., first CPU 2 and second CPU 3) and the memory controller 4.

The total latency across the I/O subsystem is equal to the sum of the following times: t_adapter+t_ibus+t_bridge+t_mbus. It is noted that the total latency across the I/O subsystem impacts the performance of the application running on the computer platform and potentially impacts applications running on computers that are connected to the platform.

A fifth time (t_memory) is expended for data to be received on the CPU/memory bus 7 from the I/O controller 6 and for the memory controller 4 to write data to memory 5 at the address specified by an address tag.

A sixth time (t_CPU) is expended by the CPU to execute a TCP/IP protocol stack for handling multiple streams of incoming data from the network adapter 8 and for delivering the data from the TCP/IP packets to a target application. The CPU is frequently interrupted to handle data flow in this prior art system.

As shown in FIG. 1, the total latency is equal to the sum of the following times: t_adapter+t_ibus+t_bridge+t_mbus+t_memory+t_CPU.

It would be desirable to have a mechanism to reduce the total latency for data transfers, thereby improving performance of the system.

Mechanical design

Current designs for computer systems suffer from mechanical design restrictions that can affect the cost, size and reliability of computers. These mechanism design restrictions include, but are not limited to, component layout restrictions, physical space restrictions, and reliability issues.

Component layout

The I/O buses used in current systems are limited to a predetermined maximum length. This trace length is typically around twelve inches depending on the bus speed and number of loads placed on the bus. This short distance requires that I/O controllers be disposed physically close to the I/O slot, thereby restricting a potentially more efficient layout.

Physical space

Physical space must be provided for slots to accommodate the I/O adapter cards. This requirement for physical space reduces the density of the platform and increases the space taken by the system in a customer's premise.

Reliability

One disadvantage of employing adapters and an I/O bus is that the mechanical connectors between adapter and I/O bus are often a major cause of failure in current system design.

Cost

In current designs, costs are incurred for I/O adapters, an I/O controller, and the provision of physical slots for I/O adapters. These costs include costs associated with connectors, sheet metal, cooling devices and power supply requirements.

Based on the foregoing, there remains a need for a direct TCP/IP communication method and system for coupling to a CPU/memory complex that overcomes the disadvantages of the prior art as set forth previously.

### SUMMARY OF THE INVENTION

According to one embodiment of the present invention, a computer system that includes a processor/memory complex and a TCP/IP controller integrated with the processor/memory complex is provided. The TCP/IP controller supports TCP/IP connections to and from the processor/memory complex. The TCP/IP controller executes the TCP/IP protocol on data received from a network connection and data to be sent to a network connection.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a prior art computer system.

FIG. 2 is a block diagram illustrating a system that includes a TCP/IP controller in accordance with one embodiment of the present invention.

FIG. 3 is a flow chart illustrating the steps performed by the TCP/IP controller in accordance with one embodiment of the present invention.

FIG. 4 illustrates in greater detail the TCP/IP controller of FIG. 2 in accordance with one embodiment of the present invention.

FIG. 5 illustrates in greater detail the TCP/IP controller of FIG. 2 in accordance with an alternative embodiment of the present invention.

FIG. 6 is a block diagram illustrating a system that includes a TCP/IP controller in accordance with an alternative embodiment of the present invention.

FIG. 7 is a block diagram illustrating applications that employ a system with the TCP/IP controller in accordance with an alternative embodiment of the present invention.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

The system and method for processing network packets can be implemented in hardware, software, firmware, or a combination thereof. In one embodiment, the invention is implemented using hardware. In another embodiment, the invention is implemented using software that is executed by general purpose or an application specific processor.

In yet another alternative implementation, embodiments of the invention may be implemented using a combination of hardware and software that is stored in a memory and that is executed by a suitable instruction execution system.

The hardware portion of the invention can be implemented with one or more of the following well-known technologies: discrete logic circuits that include logic gates for implementing logic functions upon data signals, application specific integrated circuit (ASIC), a programmable gate array(s) (PGA), and a field-programmable gate array (PPGA).

The software portion of the invention can be stored in one or more memory elements and executed by a suitable general purpose or application specific processor. The program for processing packets, which comprises an ordered listing of executable instructions for implementing logical functions, can be embodied in any computer-readable medium for use by or in connection with an instruction execution system or apparatus (e.g., a computer-based system, a processor-based system, or other system that can fetch and execute the instructions).

It is noted that aspects of the present invention are described in connection with packets that conform to the TCP/IP protocol. However, it is to be appreciated that the teachings of the present invention extend to other network protocols with different formats and processing techniques and to non-network packets of information. An offload engine can be configured with processing algorithms appropriate for implementing a particular network protocol or non-network protocol.

One aspect of the invention is providing a method to support TCP/IP connections directly from/to a computer's processor/memory complex by integrating one or more TCP/IP controller(s) directly in the CPU/Memory complex. In one embodiment, one or more IP addresses may be assigned to each TCP/IP controller. For example, one or more IP addresses may be assigned to the TCP/IP controller(s) by a system manager or system administrator. The TCP/IP controller(s) can offload the TCP protocols and UDP protocols to an integrated TCP/IP offload Engine (referred to herein also as TOE).

The TCP/IP controller according to the invention provides several performance and design improvements over prior art computer I/O sub-system designs. These improvements include, but are not limited to, the reduction of latency when transferring data, lower cost for system construction, and a more simple mechanical system design that does not need I/O buses, I/O adapters and I/O adapter slots therefore improving reliability.

The TCP/IP controller according to the invention also solves several problems that exist with prior art computer I/O subsystem design, which use several stages to transfer TCP/IP data from the network point of attachment to the CPU or memory.

Computer System 200

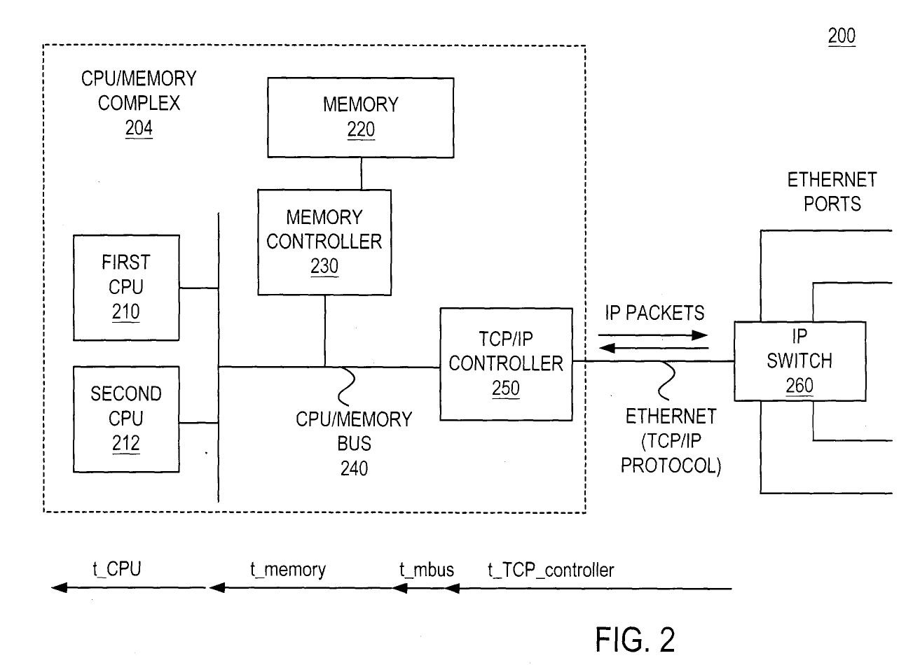

FIG. 2 is a block diagram illustrating a computer system 200 that includes a TCP/IP controller 250 in accordance with one embodiment of the present invention. The system 200 includes a CPU/memory complex 204 that includes a TCP/IP controller 250 according to the invention. The CPU/memory complex 204 is coupled to a network (e.g., an IP switch 260) through a communication media (e.g., an Ethernet connection) that complies with a communication protocol (e.g., a TCP/IP protocol). Data (e.g., IP packets) may be sent to or received from the network in the CPU/memory complex 204 through the TCP/IP controller 250. The IP switch 260 can be coupled to other network nodes through one or more ports (e.g., Ethernet ports).

The CPU/memory complex 204 includes one or more processors (e.g., a first central processing unit 210 and a second central processing unit 212) for executing programs or software applications, a memory 220 for storing information, a memory controller 230 that is coupled to the memory 220 for controlling access (e.g., read access or write access) to the memory 220, and a processor bus 240 (also referred to herein as a memory bus 240 or a CPU/memory bus 240) for coupling together and providing data communication between the processors (e.g., first CPU 210 and second CPU 212), the memory controller 230 and the TCP/IP controller 250.

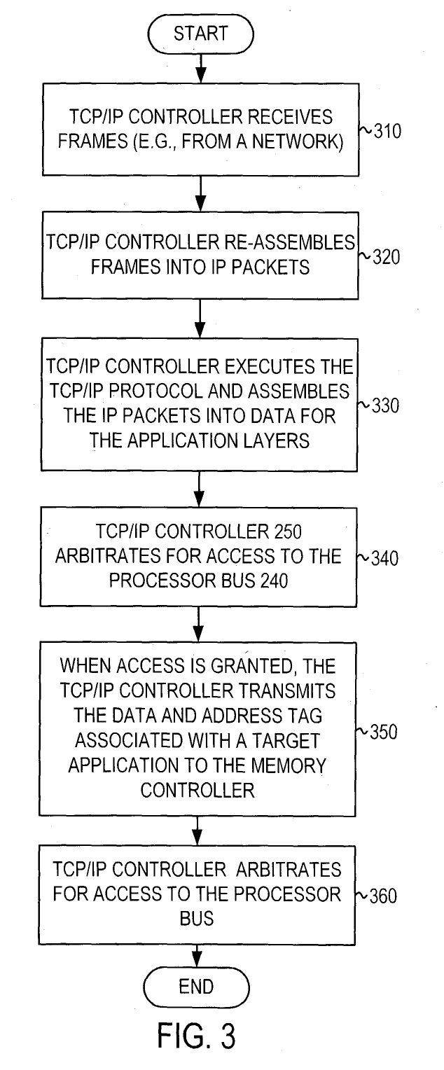

The TCP/IP controller 250 according to the invention is directly coupled to the processor/memory bus 240 without any intervening adapters, input/output bus, or input/output controllers that exist in prior art systems. The operation of the TCP/IP controller 250 is described in greater detail hereinafter with reference to FIG. 3.

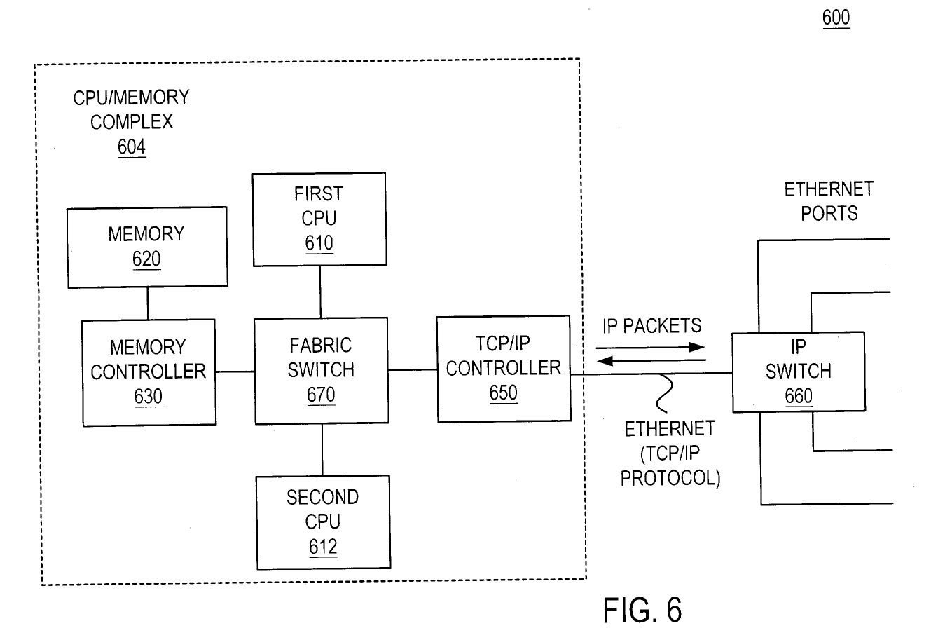

Although FIG. 2 illustrates an exemplary design implementation of the TCP/IP controller 250 that is connected directly to the processor bus 240, it is noted that other interconnect mechanisms may be employed to couple the TCP/IP controller 250, memory controller 230 and processors (e.g., 210 and 212). For example, an exemplary system, in which the processors 210, memory controller 230 and TCP/IP controllers 250 are connected via a switch fabric, is described in greater detail hereinafter with reference to FIG. 6.

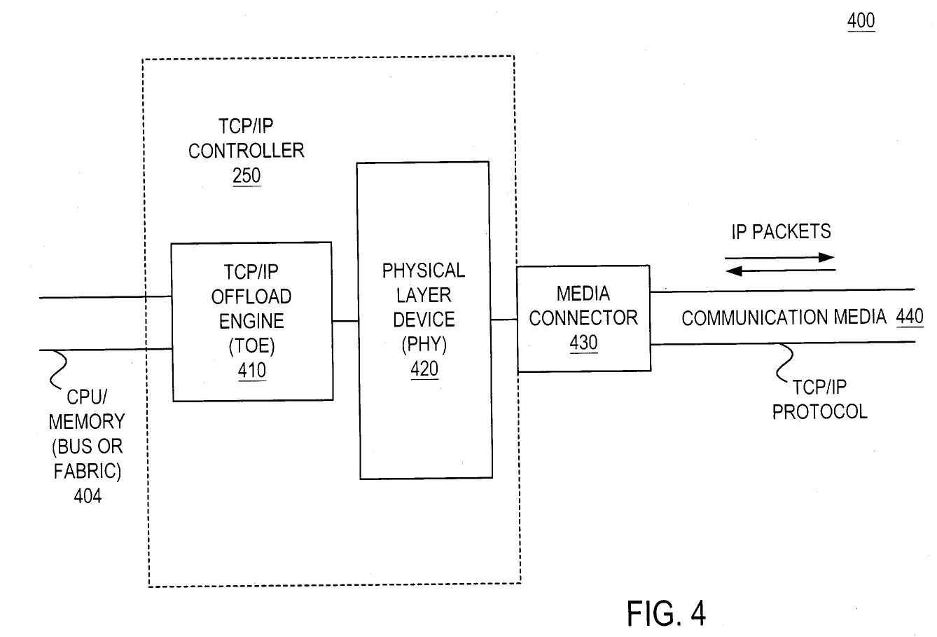

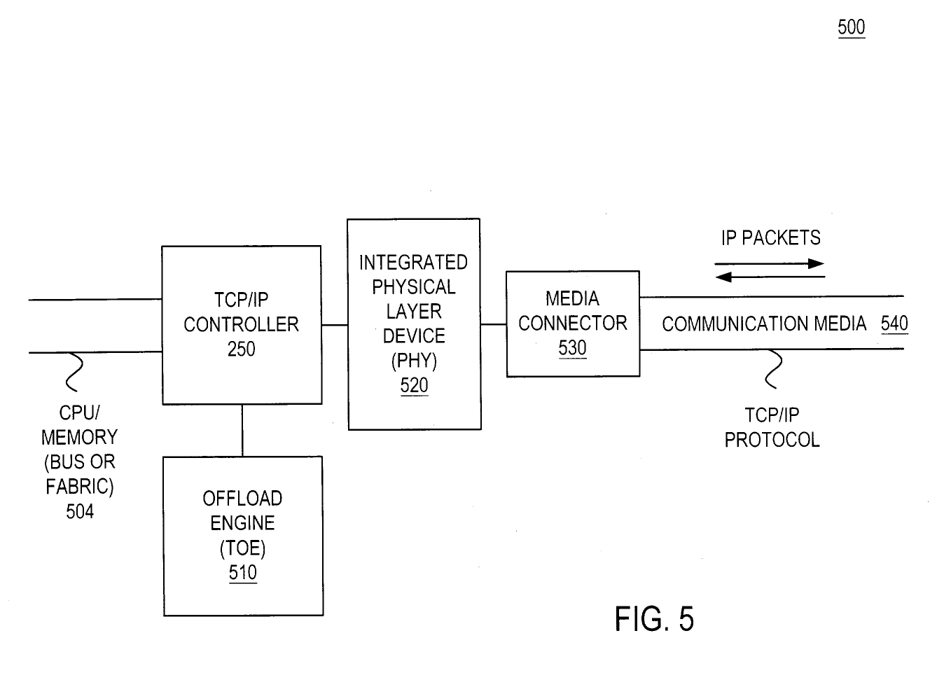

The TCP/IP controller 250 is also coupled to a source 260 of network packets (e.g., IP packets). The connection between the TCP/IP controller 250 and the source 260 of packets is described in greater detail hereinafter with reference to FIGS. 4 and 5. The source 260 of packets can be, for example, a network switch (e.g., an IP switch). In this example, the network switch 260 also includes a plurality of ports (e.g., Ethernet ports) to transmitting or receiving packets of information.

Processing Steps Performed by the TCP/IP Controller 250

In this example, the processor 210 is executing a target application that requires data from an input/output device. FIG. 3 is a flow chart illustrating the steps performed by the TCP/IP controller 250 in accordance with one embodiment of the present invention. In step 310, frames are received (e.g., from a network). For example, the TCP/IP controller 250 receives Ethernet frames from the network (e.g., from an IP switch 260). In step 320, the frames are re-assembled into IP packets by the TCP/IP controller 250. Step 320 can also include the sub-step of checking for errors in the re-assembled IP packets. In step 330, the TCP/IP controller 250 executes the TCP/IP protocol and assembles the IP packets into data for the application layers.

In step 340, the TCP/IP controller 250 arbitrates for access to the processor bus 240. In step 350, when access is granted, the TCP/IP controller 250 transmits the data and address tag associated with a target application to the memory controller 230. For example, data is received on the processor bus 240 from the TCP/IP controller 250. The memory controller 250 then writes the data into memory 220 at the address specified by the address tag.

In step 360, the TCP/IP controller 250 interrupts the processor 210 when data is available for the target application. For example, the processor 210 is interrupted when data is available for processing by the target application.

In one embodiment that employs the Internet Model (also referred to as the TCP/IP model), the step of executing a TCP/IP protocol can include the following sub-steps: 1) performing network layer processing on a received frame to generate a corresponding datagram; 2) performing Internet layer processing on the datagram to generate a corresponding segment; 3) performing transport layer processing on the segment to generate a corresponding message; and 4) providing the message to a target application in the application layer in a data format that is specified by the target application interface, for example.

I/O Subsystem Performance/Latency

As data flows from the network point of attachment to the processor/memory complex, the data is delayed by the following delay times.

A first time (t_TCP controller) is taken to reassemble the IP packets, perform error checks and for the data to propagate across the TCP/IP controller 250 to the output buffers on the processor bus 240.

A second time (t_mbus) is taken to arbitrate for and be granted access to the processor bus 240 and to transfer data to the memory controller 230. This time is non-deterministic due to competing requests for access to the processor bus 240 from the processors 210 and the memory controller 230.

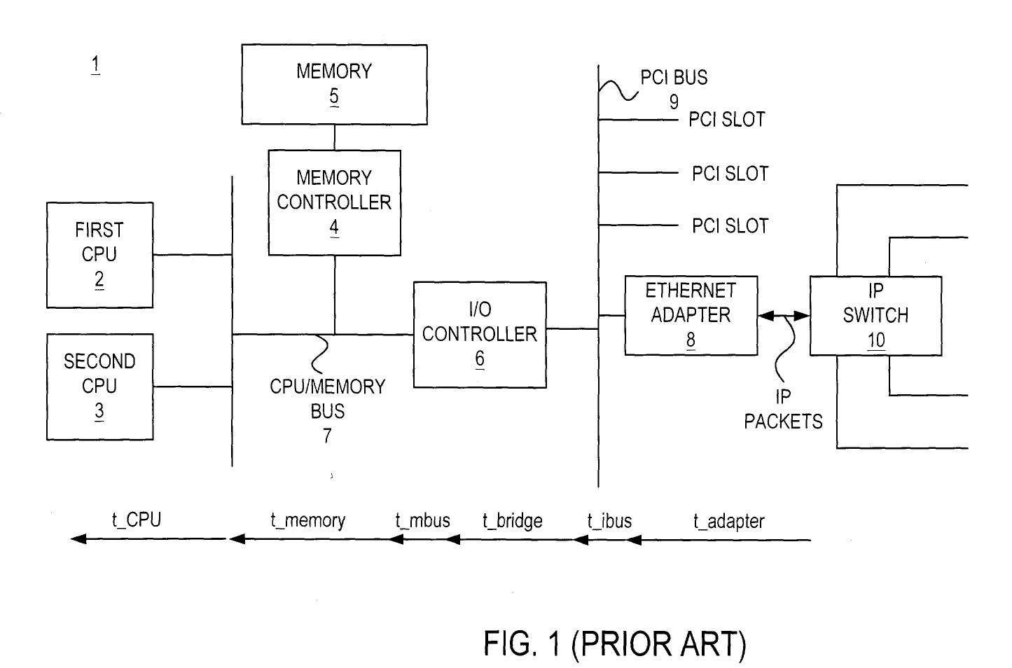

Referring again to FIG. 3, the total latency or time delay may be calculated by the following expression: Total latency=t_TCP controller+t_mbus. It is noted that the latency incurred by a system that employs the TCP/IP controller 250 according to the invention is less than the latency of prior computer system (e.g., the system of FIG. 1) designs that utilize an I/O bus, adapter slots, and I/O controllers.

The computer system according to the invention eliminates the latency across the I/O bus (t_ibus) and the latency across the I/O bridge (t_bridge). The latency across the TCP/IP controller 250 (t_TCP controller) and latency across the Ethernet adapter (t_adapter) are expected to be comparable.

The lower latency provided by computer systems that utilize the TCP/IP controller according to the invention can provide significant application performance improvements. Furthermore, the TCP/IP controller according to the invention can also improve the predictability of a computers' performance as the non-deterministic latency across the I/O bus (t_ibus) is eliminated.

The TCP/IP controller according to the invention solves the following mechanical design restrictions affecting the cost, size and reliability of computers.

Component layout

The TCP/IP controller according to the invention obviates the need for I/O buses, thereby removing the issues around I/O bus trace lengths and bus routing.

Physical space

The TCP/IP controller according to the invention also obviates the need for I/O slots, thereby allowing a reduction in the size of computer systems and the physical space occupied by such computer systems.

Reliability

The TCP/IP controller according to the invention further obviates the need for mechanical connectors, thereby removing a source of failure in the system.

Cost

The TCP/IP controller according to the invention obviates the cost of I/O adapters and I/O controllers and the cost of providing physical slots for I/O adapters. For example, connectors, sheet metal, cooling systems, and power supplies associated with I/O adapters and I/O controllers are eliminated from the system.

One novel aspect of the invention is that the TCP/IP controller according to the invention is directly coupled to the CPU/Memory complex through an interconnect mechanism without the need for an intermediary I/O bus or channel such as a PCI bus. FIG. 4 illustrates a system in which the TCP/IP controller is coupled to the processor/memory complex (PMC) via a processor bus. FIG. 5 illustrates a system in which the TCP/IP controller is coupled to the processor/memory complex via a switch fabric.

In one embodiment, the circuits to physically connect to the network media are integrated with the TCP/IP controller 250. In an alternative embodiment, the circuits to physically connect to the network media are implemented external to the TCP/IP controller 250.

Regarding the TCP/IP offload engine (TOE), in one embodiment, the TOE is integrated with the TCP/IP controller 250. In an alternative embodiment, the TOE is implemented external to the TCP/IP controller 250.

The TCP/IP controller 250 may be designed as a separate integrated circuit (IC) or integrated with other components of a computer chipset. For example, the TCP/IP controller 250 may be integrated with the memory controller 230 or one of the processors 210.

When embodied in an integrated circuit, the TCP/IP controller 250 may be assembled onto a motherboard, a sub-system printed circuit board, or on separate card that can be inserted into a chassis (commonly referred to as a “blade”) that is coupled to the processors and memory through an interconnect mechanism.

FIG. 4 illustrates in greater detail the TCP/IP controller 250 of FIG. 2 in accordance with one embodiment of the present invention. The TCP/IP controller 250 is coupled to the processor/memory complex 204 through an interconnect mechanism 404 and is also coupled to a communication media 440 through a media connector 430. As described in greater detail hereinafter, the interconnect mechanism 404 can be a processor bus or a switch fabric.

A media connector 430 is provided for coupling the physical layer device 420 to the network media 440. The communication media or network media 440 can be, for example, but is not limited to, conductive or electric wires, optical cables (e.g., Fibre cables), or wireless channels or links.

The TCP/IP controller 250 includes a TCP/IP offload engine (TOE) 410 for executing the TCP protocols and UDP protocols and a physical layer device (PHY) 420 for physically connecting the TCP/IP controller 250 to the communication media 440. In this embodiment, the TCP/IP offload engine 410 and the physical layer device 420 are integrated with the TCP/IP controller 250.

FIG. 5 illustrates in greater detail the TCP/IP controller 250 of FIG. 2 in accordance with an alternative embodiment of the present invention. The TCP/IP controller 250 is coupled to the processor/memory complex 204 through an interconnect mechanism 504 (e.g., a processor bus or switch fabric). The TCP/IP controller 250 includes an offload engine 510 for executing the TCP protocols and UDP protocols, the physical layer device 520 for physically connecting the TCP/IP controller 250 to network media. In this embodiment, the offload engine 510 and the physical layer device (PHY) 520 are external to the TCP/IP controller 250.

A media connector 530 is provided for coupling the physical layer device (PHY) 520 to the communication or network media 540. The communication media 540 communicates protocol data units (PDUs) (e.g., IP packets) in accordance with a communication protocol (e.g., the TCP/IP protocol). The communication media or network media 540 can be, for example, but is not limited to, conductive or electric wires, optical cables (e.g., Fibre cables), or wireless channels or links.

As described above, the TCP/IP controller can be implemented using either external physical layers or integrated physical layers for connections to the physical network media, such as copper wires or optical fiber cables, that are designed to operate at a variety of link speeds, which depend on the technology employed.

System with Switch Fabric

FIG. 6 is a block diagram illustrating a system 600 that includes a TCP/IP controller 250 in accordance with an alternative embodiment of the present invention. For the sake of brevity, the description of the components of system 600 that are common to previously described components are not repeated herein. In this embodiment, the interconnect mechanism for coupling the TCP/IP controller 250 to the memory controller and processors is a switch fabric 670. The switch fabric 670 facilitates inter-processor communication by providing multiple communication paths between memory and the processors. The switch fabric is commonly found in computer systems that employ eight or more processors or in applications where the data traffic between processors cannot be handled efficiently with a processor or memory bus.

Exemplary Applications

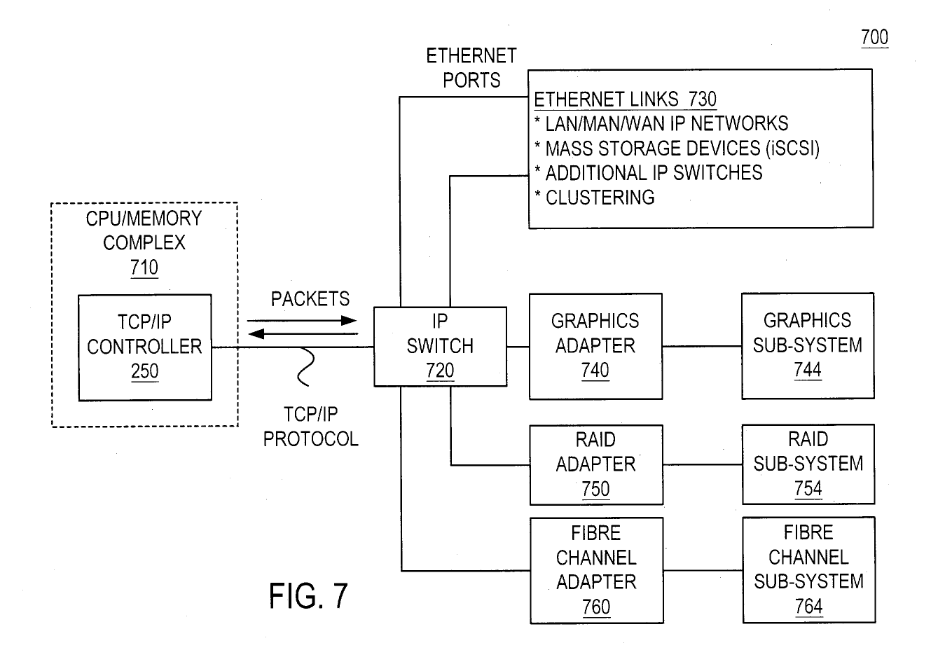

FIG. 7 is a block diagram illustrating exemplary applications that may be supported by a system with the TCP/IP controller 250 in accordance with the present invention. The system 700 includes a processor/memory (CPU/memory) complex 710 that includes the TCP/IP controller 250 according to the invention. An IP switch 720 is coupled to the processor/memory complex 710 and communicates information therewith by employing a predetermined protocol (e.g., the TCP/IP protocol). For example, TCP packets or UDP packets are communicated between the TCP/IP controller 250 and the IP switch 720. The IP switch 720 includes a plurality of ports for directly coupling to network links, such as IP networks, and indirectly coupling to legacy non-IP based I/O links.

The IP-based network links 730 (e.g., Ethernet links) can include, but are not limited to, local area networks (LAN), metropolitan area networks (MAN), and wide area networks (WAN), IP networks.

Given an industry trend to support storage over IP (e.g., network attached storage (NAS), IP over SCSI (iSCSI), fibre channel over IP (FCIP), etc.), the TCP/IP controller 250 according to the invention supports the elimination of adapter cards and the I/O buses/channels required to connect the adapter cards to the processor or memory.

Supporting Legacy I/O connectivity

FIG. 7 illustrates shows how the TCP/IP controller 250 according to the invention supports module system design. Computer designs that employ the TCP/IP controller 250 according to the invention can provide connections to storage devices, to nodes within a cluster, and to legacy networks and devices to protect existing customer investments.

The legacy non-IP based I/O links 740 can include, but are not limited to, Graphics adapter 740 for coupling to a graphics sub-system 744 (e.g., a monitor), for example, a redundant array of inexpensive disks (RAID) adapter 750 for coupling to a RAID sub-system 754 (e.g., an array of SCSI disk drives), and a Fibre Channel adapter 760 for coupling to a storage subsystem 764 (e.g., an array of disk drives or tape drives). It is noted that a respective adapter card is provided between the IP switch 720 and the sub-system.

The principles of the present invention are described in the context of packets received from a network that complies with the TCP/IP protocols. However, it is noted that the teaching of the present invention can be applied to other network protocols.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A computer system for coupling to a network comprising:
a) a processor/memory complex; and
b) a TCP/IP controller integrated with the processor/memory complex for supporting TCP/IP connections to and from the processor/memory complex;
wherein the TCP/IP controller executes the TCP/IP protocol on data received from the network and data to be sent to the network.

2. The computer system of claim 1 wherein the TCP/IP controller includes a network connection for directly coupling to the network.

3. The computer system of claim 2 wherein the TCP/IP controller further comprises:
an offload engine for executing one of a TCP protocol and a UDP protocol on data received from the network and data to be sent to the network.

4. The computer system of claim 1 wherein the TCP/IP controller is assigned at least one IP address.

5. The computer system of claim 1 wherein the TCP/IP controller further comprises:
an integrated physical layer device for coupling to a communication media.

6. The computer system of claim 5 wherein the communication media includes one of conductive wire, optical cable, and a wireless link.

7. The computer system of claim 1 wherein the system further comprises:
a physical layer device external to the TCP/IP controller for coupling to a communication media.

8. The computer system of claim 7 wherein the communication media includes one of conductive wire, optical cable, and a wireless link.

9. The computer system of claim 1 wherein the TCP/IP controller reduces latency of data transfer by obviating the need for I/O buses, I/O adapters and I/O adapter slots.

10. The computer system of claim 1 wherein the processor/memory complex further comprises:
a processor for executing instructions;
a memory;
a memory controller for controlling access to the memory; and
an interconnect mechanism for coupling the processor, the memory controller, and the TCP/IP controller.

11. The computer system of claim 10 wherein the interconnect mechanism includes a processor bus.

12. The computer system of claim 10 wherein the interconnect mechanism includes a switch fabric.

13. A computer system for coupling to a network comprising:
a) a processor/memory complex; and
b) means integrated with the processor/memory complex for supporting TCP/IP connections to and from the processor/memory complex;
wherein TCP/IP support means executes the TCP/IP protocol on data received from the network and data to be sent to the network.

14. The computer system of claim 13 wherein the TCP/IP support means includes means for directly coupling to the network.

15. The computer system of claim 1 wherein the TCP/IP support means further comprises:
means for executing one of a TCP protocol and a UDP protocol on data received from the network and data to be sent to the network.

16. The computer system of claim 1 wherein the TCP/IP support means further includes:
means for receiving frames from the network;
means for performing network layer processing on the frame to generate a corresponding datagram;
means for performing Internet layer processing on the datagram to generate a corresponding segment;
means for performing transport layer processing on the segment to generate a corresponding message; and
means for providing the message to an application layer.

17. A method for processing information received from a network in a system that includes a CPU/memory complex, a TCP/IP controller integrated with the CPU/memory complex that includes a network connection for directly connecting to the network, and a target application, the method comprising the steps of:
a) receiving frames from the network;
b) re-assembling the received frames into IP packets;
c) executing a TCP/IP protocol and assembling the IP packets into a data format specified by the target application in the application layer;
d) arbitrating for access to the processor bus;
e) when access is granted, transmitting data and a memory address tag associated with the target application to a memory controller; and
f) interrupting the processor when data is available for the target application.

18. The method of claim 17
wherein the step of executing a TCP/IP protocol and assembling the IP packets into data for the application layers includes the step of
checking for errors in the re-assembled IP packets.

19. The method of claim 17
wherein the step of executing a TCP/IP protocol and assembling the IP packets into data for the application layers includes the step of
performing network layer processing on the frame to generate a corresponding datagram;
performing Internet layer processing on the datagram to generate a corresponding segment;
performing transport layer processing on the segment to generate a corresponding message; and
providing the message to the application layer.

20. The method of claim 17
wherein the step of when access is granted, transmitting data and an address tag associated with the target application to a memory controller includes the step of
writing the data into a memory at the address specified by the address tag.
